(19) United States
(12) Patent Application Publication
(10) Pub. No.: US 2025/0162151 A1
(43) Pub. Date: May 22, 2025

(54) SEGMENTATION OF DETECTED OBJECTS INTO OBSTRUCTIONS AND ALLOWED OBJECTS

(71) Applicant: Seegrid Corporation, Pittsburgh, PA (US)

(72) Inventors: Benjamin G. Schmidt, Wexford, PA (US); Erich L. Foster, Pittsburgh, PA (US)

(21) Appl. No.: 18/839,465

(22) PCT Filed: Mar. 28, 2023
(86) PCT No.: PCT/US2023/016612

§ 371 Date: Aug. 19, 2024

Related U.S. Application Data
(60) Provisional application No. 63/324,198, filed on Mar. 28, 2022.

(51) Int. Cl. B25J 9/16; G05D 1/622; G06T 7/12; G06T 7/70

(52) U.S. Cl. CPC B25J 9/1666; B25J 9/1697; G05D 1/622; G06T 7/12; G06T 7/70; G06T 2207/30261

(57) ABSTRACT

In accordance with one aspect of the inventive concepts, provided is an autonomous mobile robot, comprising: at least one processor in communication with at least one computer memory device; at least one sensor configured to acquire point cloud data; a pallet detection system configured to provide a pose of a payload; and an object segmentation system comprising computer program code executable by the at least one processor to segment detected objects into obstructions and allowed objects based on the point cloud data, the pose of the payload and semantic data about the payload. A corresponding method is also provided.

### CROSS REFERENCE TO RELATED APPLICATIONS

The present application claims priority to U.S. Provisional Appl. 63/324,198 filed on Mar. 28, 2022, entitled SEGMENTATION OF DETECTED OBJECTS INTO OBSTRUCTIONS AND ALLOWED OBJECTS, which is incorporated herein by reference in its entirety.

The present application may be related to US Provisional Appl. 63/430,184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; US Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. 63/348,520 filed on Jun. 3, 2022, entitled System and Method for Generating Complex Runtime Path Networks from Incomplete Demonstration of Trained Activities; U.S. Provisional Appl. 63/410,355 filed on Sep. 27, 2022, entitled Dynamic, Deadlock-Free Hierarchical Spatial Mutexes Based on a Graph Network, U.S. Provisional Appl. 63/346,483 filed on May 27, 2022, entitled System and Method for Performing Interactions with Physical Objects Based on Fusion of Multiple Sensors; and U.S. Provisional Appl. 63/348,542 filed on Jun. 3, 2022, entitled Lane Grid Setup for Autonomous Mobile Robots (AMRs); U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; each of which is incorporated herein by reference in its entirety.

The present application may be related to US Provisional Appl. 63/324,182 filed on Mar. 28, 2022, entitled A Hybrid, Context-Aware Localization System For Ground Vehicles; U.S. Provisional Appl. 63/324,184 filed on Mar. 28, 2022, entitled Safety Field Switching Based On End Effector Conditions; US Provisional Appl. 63/324,185 filed on Mar. 28, 2022, entitled Dense Data Registration From a Vehicle Mounted Sensor Via Existing Actuator; U.S. Provisional Appl. 63/324,187 filed on Mar. 28, 2022, entitled Extrinsic Calibration Of A Vehicle-Mounted Sensor Using Natural Vehicle Features; U.S. Provisional Appl. 63/324,188 filed on Mar. 28, 2022, entitled Continuous And Discrete Estimation Of Payload Engagement/Disengagement Sensing; U.S. Provisional Appl. 63/324,190 filed on Mar. 28, 2022, entitled Passively Actuated Sensor Deployment; U.S. Provisional Appl. 63/324,192 filed on Mar. 28, 2022, entitled Automated Identification Of Potential Obstructions In A Targeted Drop Zone; US Provisional Appl. 63/324,193 filed on Mar. 28, 2022, entitled Localization Of Horizontal Infrastructure Using Point Clouds; U.S. Provisional Appl. 63/324,195 filed on Mar. 28, 2022, entitled Navigation Through Fusion of Multiple Localization Mechanisms and Fluid Transition Between Multiple Navigation Methods; U.S. Provisional Appl. 62/324,199 filed on Mar. 28, 2022, entitled Validating The Pose Of An AMR That Allows It To Interact With An Object, and U.S. Provisional Appl. 63/324,201 filed on Mar. 28, 2022, entitled A System For AMRs That Leverages Priors When Localizing Industrial Infrastructure; each of which is incorporated herein by reference in its entirety.

The present application may be related to U.S. patent application Ser. No. 11/350,195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design Patent Appl. 29/398,127, filed on Jul. 26, 2011, U.S. Pat. No. D680,142, Issued on Apr. 16, 2013, entitled Multi-Camera Head, U.S. Design Patent Application Ser. No. 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4, 2020, US Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022-0100195, published on Mar. 31, 2022, entitled Vehicle Object-Engagement Scanning System And Method; U.S. patent application Ser. No. 17/478,338, filed on Sep. 17, 2021, US Publication Number 2022-0088980, published on Mar. 24, 2022, entitled Mechanically-Adaptable Hitch Guide each of which is incorporated herein by reference in its entirety.

### FIELD OF INTEREST

The present inventive concepts relate to systems and methods in the field of autonomous and/or robotic vehicles. Aspects of the inventive concepts are applicable to any mobile robotics application involving manipulation. More specifically, the present inventive concepts relate to systems and methods of segmentation of detected objects into obstructions and allowed objects.

### BACKGROUND

A robotic vehicle such as an autonomous mobile robot (AMR), needs to be able to make physical contact and engagement with payloads in order to interact with them. Object Obstruction detection systems on the AMR are designed to prevent the AMR from making physical contact with objects perceived as obstructions and/or safety hazards. These systems are not able to determine with which objects the AMR is permitted to make physical contact, and with which objects it is not. Current obstruction detection systems are turned off as the AMR approaches a payload with which it is going to interact. This allows the AMR to make contact and engage with the payload, but also introduces the risk of making contact with other objects.

### SUMMARY OF THE INVENTION

In accordance with one aspect of the inventive concepts, provided is an autonomous mobile robot, comprising: at least one processor in communication with at least one computer memory device; at least one sensor configured to acquire point cloud data; a pallet detection system configured to provide a pose of a payload; and an object segmentation system comprising computer program code executable by the at least one processor to segment detected objects into obstructions and allowed objects based on the point cloud data, the pose of the payload and semantic data about the payload.

In various embodiments, the at least one processor provides an expected pose of the payload.

In various embodiments, the object segmentation system generates at least one first region around the payload based on the pose of the payload and the expected pose of the payload.

In various embodiments, the at least one first region is an at least one three-dimensional box.

In various embodiments, the object segmentation system generates at least one second region between forks of the robot and outriggers of the robot based on the expected pose of the payload and an expected pose of the robot.

In various embodiments, the at least one second region is an at least one three-dimensional box.

In various embodiments, the object segmentation system is configured to filter out points from the point cloud data based on the at least one first region and the at least one second region.

In various embodiments, the processor is configured to not use the filtered out points for obstruction detection.

In various embodiments, the at least one sensor comprises at least one of a LiDAR scanner and a 3D camera.

In various embodiments, the AMR includes a pair of forks and the payload is a palletized payload.

In accordance with another aspect of the inventive concepts, provided is a method of an autonomous mobile robot segmenting detected objects into obstructions and allowed objects, comprising: at least one sensor acquiring point cloud data; a pallet detection system providing a pose of a payload; and an object segmentation system segmenting detected objects into obstructions and allowed objects based on the point cloud data, the pose of the payload and semantic data about the payload.

In various embodiments, the method further includes the at least one processor providing an expected pose of the payload.

In various embodiments, the method further includes the object segmentation system generating at least one first region around the payload based on the pose of the payload and the expected pose of the payload.

In various embodiments, the at least one first region is an at least one three-dimensional box.

In various embodiments, the method further includes the object segmentation system generating at least one second region between forks of the robot and outriggers of the robot based on the expected pose of the payload and an expected pose of the robot.

In various embodiments, the at least one second region is an at least one three-dimensional box.

In various embodiments, the method further includes the object segmentation system filtering out points from the point cloud data based on the at least one first region and the at least one second region.

In various embodiments, the method further includes the processor excluding the filtered out points for obstruction detection.

In various embodiments, the at least one sensor comprises at least one of a LiDAR scanner and a 3D camera.

In various embodiments, the AMR includes a pair of forks and the payload is a palletized payload.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1 is a perspective view of an embodiment of an AMR forklift that can be configured to implement segmentation of detected objects into obstructions and allowed objects, in accordance with aspects of the inventive concepts.

FIG. 2 is a diagram illustrating an embodiment of three-dimensional boxes generated by an object segmentation system, in accordance with aspects of the inventive concepts.

FIG. 3 is a schematic block diagram of the AMR forklift of FIGS. 1 and 2.

FIG. 4 is a block diagram of a method of the AMR forklift of FIGS. 1 and 2 of segmenting detected objects into obstructions and allowed objects.

### DESCRIPTION OF PREFERRED EMBODIMENT

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

In the context of the inventive concepts, and unless otherwise explicitly indicated, a “real-time” action is one that occurs while the AMR is in-service and performing normal operations. This is typically in immediate response to new sensor data or triggered by some other event. The output of an operation performed in real-time will take effect upon the system so as to minimize any latency.

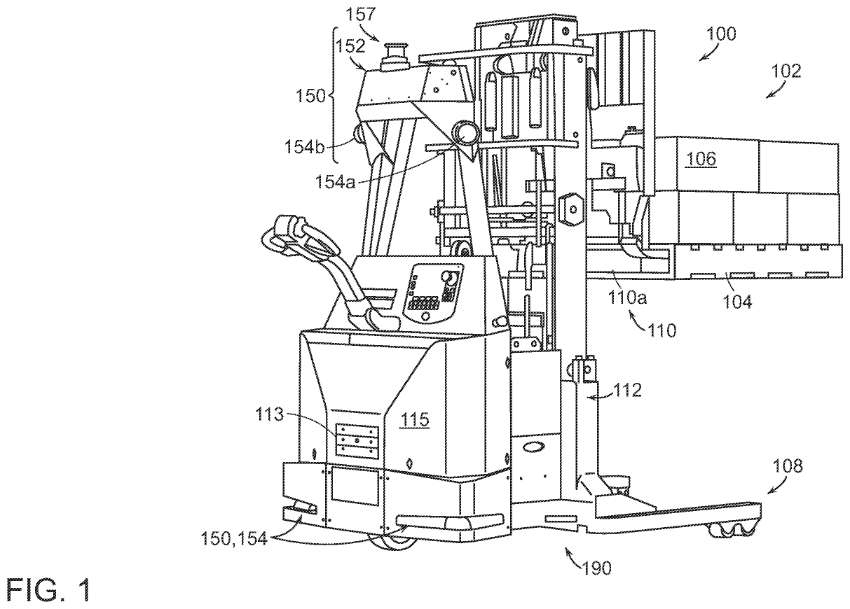

FIG. 1 is a perspective view of an autonomous mobile robot (AMR) forklift 100 that can be configured to implement segmentation of detected objects into obstructions and allowed objects, in accordance with aspects of the inventive concepts. Allowed objects include objects to be engaged by the AMR for transport, such as a pallet or a cart. In some embodiments, allowed objects can include other objects or structures, such as a charging station. Obstructions may broadly be considered as any structure, apparatus, or other physical entity that interferes with the AMRs route and/or operation. Herein, the inventive concepts are described within the context of AMRs, but they can be implemented with various other types of robotic vehicles, e.g., tuggers. The system according to the present inventive concepts allows a robotic vehicle to physically interact with a desired allowed object that is located on top of infrastructure, while still avoiding contact with any other detected obstruction objects.

Referring to FIG. 1, shown is an example of a robotic vehicle 100 in the form of an AMR that can be configured with the sensing, processing, and memory devices and subsystems necessary and/or useful for performing segmentation of detected objects into obstructions and allowed objects, in accordance with aspects of the inventive concepts. The robotic vehicle 100 takes the form of an AMR pallet lift, but the inventive concepts could be embodied in any of a variety of other types of robotic vehicles and AMRs, including, but not limited to, pallet trucks, tuggers, and the like.

In this embodiment, the robotic vehicle 100 includes a payload area 102 configured to transport a payload, e.g., pallet 104 loaded with goods. The payload 106 can take the form of a palletized load in some embodiments. To engage and carry the pallet 104, the robotic vehicle may include a pair of forks 110, including a first and second forks 110a,b, that slide into pockets of the pallet 104. Outriggers 108 extend from the robotic vehicle in the direction of the forks to stabilize the vehicle, particularly when carrying the palletized payload 106. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for detecting objects, e.g., pallets and payloads and obstructions, such as hazards, humans, other robotic vehicles, and/or congestion during navigation. The sensors 150 can include one or more cameras, stereo cameras 152, radars, and/or laser imaging, detection, and ranging (LiDAR) scanners 154.

In the embodiment shown in FIG. 1, there are two LiDAR devices 154a, 154b positioned at the top of the robotic vehicle 100. In the embodiment shown in FIG. 1, one of the LiDAR devices near the top of the robotic vehicle 154a is a 2D LiDAR device. In the embodiment shown in FIG. 1, one of the LiDAR devices near the top of the robotic vehicle 154a is a 3D LiDAR device. In alternative embodiments, a different number of 2D LiDAR devices are positioned near the top of the robotic vehicle 100. In alternative embodiments, a different number of 3D LiDAR devices are positioned near the top of the robotic vehicle 100. In the embodiment shown in FIG. 1, there is a sensor 157, for example, a 2D LiDAR, positioned at the top of the robotic vehicle 100 that can be used in vehicle localization.

One or more of the sensors 150 can form part of a 2D or 3D high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space. In some embodiments, the sensors 150 can include carriage sensors 156 configured to detect objects in the payload area and/or behind the forks 110a,b. The carriage sensors 156 can be used in combination with others of the sensors 150, e.g., stereo camera head 152.

In computer vision and robotic vehicles, a typical task is to identify specific objects in an image and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle.

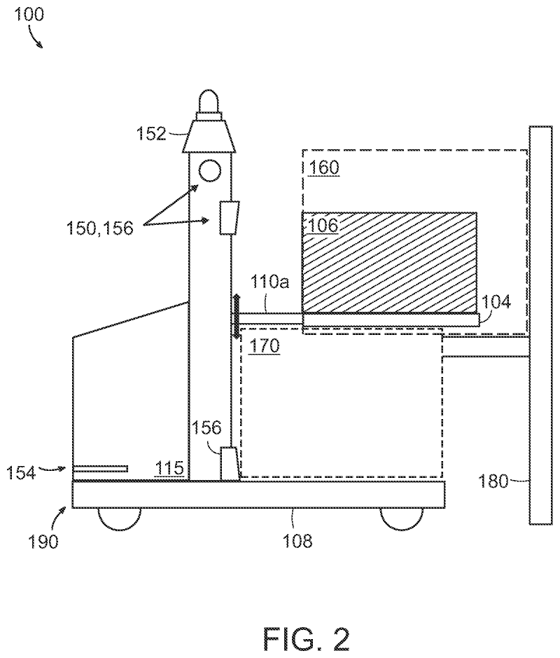

Referring to FIG. 2, by using a combination of the sensors 150 to determine the location of the payload 106 to interact with, the region occupied by the payload can be “blanked” by creating at least one three-dimensional (3D) region (e.g., a box) around the payload. In FIG. 2, this is depicted as payload region 160. The 3D payload region 160 can be used to logically filter out any detected points in a point cloud that comes from obstruction sensors (e.g., 156), such as onboard LiDAR scanners and/or cameras. The payload 3D region 160 is a first three-dimensional region around the payload 106 generated based on the pose of the payload 106 and the expected pose of the payload 106. In some embodiments, the payload 3D region 160 may comprise a plurality of 3D regions.

Point cloud data can be determined from at least one sensor 150, such as a 3D sensor, for example sensors 152, 156. A 3D sensor can be a stereo camera and/or a 3D LiDAR, as examples. As mentioned above, point cloud data is sensor data representing occupancy of voxels in a 3D grid representing the real world. If a voxel is indicated as occupied, then an object exists in the corresponding point in the real world.

Similarly, a second region at the position necessary to interact with the payload 106 can also be “blanked” in order to allow portions (e.g., outriggers) 108 of the AMR 100 that protrude from the bottom of the chassis 190 to move into open areas that lie below infrastructure 180, such as tables, conveyor belts, racking, or any other surface that may support the payload 106. That is, at least one chassis 3D region 170 can be generated as a second 3D region between forks 110a,b and outriggers 108 of the AMR 100 based on the expected pose of the payload 106 and an expected pose of the AMR 100 at the pickup location. In some embodiments, the chassis 3D region 170 may comprise a plurality of 3D regions. That is, one or more 3D chassis regions 170 may be provided to “blank” physical parts of the AMR. The plurality of 3D chassis regions 170, in addition to or instead of “blanking” the region between forks 110a,b and outriggers 108 of the AMR 100, may “blank” regions that are, for example, between the forks 110a,b and/or to the outside of the forks 110a,b, while still preventing the forks 110a,b from engaging with portions of the infrastructure 180, for example, such as pallet guards on the edge of a table 180 from which a pallet is being picked/dropped.

In various embodiments, the object segmentation system can be implemented using a Point Cloud Library (PCL). The PCL is an open-source library of algorithms for point cloud processing tasks and 3D geometry processing, such as occur in three-dimensional computer vision. The library includes algorithms for filtering, feature estimation, surface reconstruction, 3D registration, model fitting, object recognition, and segmentation. The PCL is known in the art, so not described in detail herein. In other embodiments, a different point cloud library could be used, such as a custom library, including the same or similar features as the PCL.

In various embodiments, the object detection system may be implemented with a pallet detection system (PDS) 200 or any system that can determine a payload and its position. The PDS 200 can include a data set that identifies different types of pallets and dimensions of features of the different pallets, such as width and spacing of pallet pockets that receive the forks of the AMR forklift. In various embodiments, the PDS can implement a semantic data model for organizing the data associated different types of pallets and their features. This pallet data can be, or include, semantic data about the payload 106, which can include dimensions of the payload. In other embodiments, a semantic data model need not be used. Rather, different models could be used for organizing data about the pallet types and their respective features and/or payloads.

A PDS and associated pallet detection method can take the form of the vehicle object-engagement scanning system and method described in U.S. Patent Publication Number US2022/0100195, which is incorporate herein by reference. In accordance with aspects of the inventive concepts disclosed in US2022/0100195, provided is a pallet transport system comprising a drive portion constructed and arranged to facilitate movement of the pallet transport and a load portion comprising a plurality of forks constructed and arranged to engage and carry at least one pallet. The plurality of forks comprises a first fork and a first sensor coupled to or disposed within a first fork tip located at a distal end of the first fork, wherein the first sensor is configured to collect sensor data. The system also includes at least one processor configured to process the sensor data to identify at least one pallet and an orientation of the at least one pallet.

In various embodiments, the object segmentation system is configured to allow obstruction detection to remain enabled the entire time the AMR is being operated, at least in part and/or with respect to some sensors or safety systems, allowing the AMR to stop for or otherwise avoid objects that may end up in the path of the AMR, while still allowing the AMR to interact with the payload 106, e.g., to pick up a pallet. Likewise, the system allows the AMR to “straddle” infrastructure 180, for example: such as by having outriggers below a table while the forks 110a,b are above the table 180, as shown in FIG. 2. This allows for interacting with a payload 106 that is set further back on a table's 180 surface.

In various embodiments, the object segmentation system according to various embodiments allows for less-strict placement of payloads 106 on available infrastructure, which can translate to less time being taken when placing the payload manually prior to pick up by the AMR 100. It also allows for a greater number of structures that the payload 106 can be placed on, and still allow the AMR 100 to be able to interact with it.

In various embodiments an AMR 100 is equipped to with object segmentation functionality to interact with payloads 106. The AMR can include one or more sensors 150 for collecting point cloud data, such as a LiDAR scanner or 3D camera; a mechanism for interpreting sensor data to determine a pose of a payload, such as a pallet detection system; semantic data about the payload with which the AMR will interact; and an object segmentation system including computer program code executable by at least one processor to define one or more 3D regions for segmenting out objects from obstruction detection based on the point cloud data, the pose of the payload, and semantic data about the payload.

In various embodiments, the object segmentation system may optionally be used in conjunction with a navigation system, which can include path assist functionality described in U.S. Patent Publication Number US20210284198, which is incorporated herein by reference. In accordance with aspects of the inventive concepts disclosed in US20210284198, a path adaptation method for a self-driving vehicle, such an AMR, can include providing a vehicle navigation path through an environment; determining a location of the vehicle relative to the path; generating one or more linear figures representing a cross-sectional outline of a shape of the vehicle projected from the vehicle location in a vehicle travel direction long the path; combining the one or more projections into a projected motion outline; acquiring object information representing an object shape from one or more sensors; and determining if the object shape overlaps the projected motion outline. If so, the method includes adjusting the vehicle navigation. If not, the method includes, continuing navigation along the path.

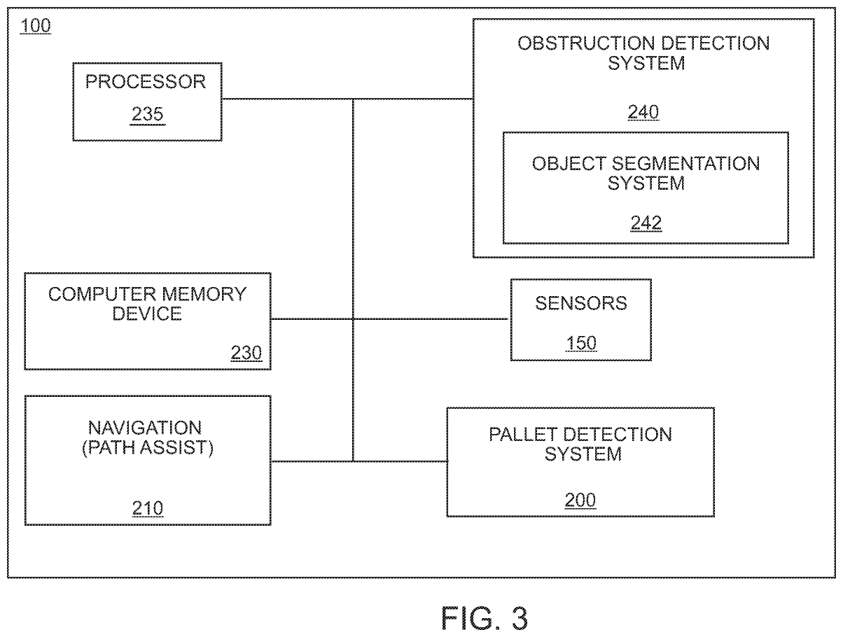

FIG. 3 is a schematic block diagram of an embodiment of functional elements of the AMR forklift of FIGS. 1 and 2. In FIG. 3, the AMR 100 includes at least one processor 235 in communication with at least one computer memory device 230; at least one sensor 150 configured to acquire sensor data, including point cloud data; a pallet detection system 200 configured to determine a pose of a payload; and an obstruction detection system 240 including and/or in communication with an object segmentation system 242 comprising computer program code executable by the at least one processor 235 to process at least some of the point cloud data to generate a first 3D exclusion box around the payload and a second 3D exclusion box between the forks at a payload engagement position and the outriggers of the AMR and to segment detected objects within the first and second 3D boxes out of the point cloud data for purposes of obstruction detection. The obstruction detection system 240 is used for processing sensor data, including point cloud data from sensors 150, to detect objects in the path of the AMR and relay signals to the navigation system 210 to halt or adapt the AMR navigation in response to avoid collisions.

Once the object segmentation system 242 has removed these regions from obstruction avoidance, a navigation subsystem 210 of the AMR 100 can navigate the AMR to avoid detected obstructions, of any, and engage the payload 106. The at least one processor 235 provides an expected pose of the payload, which may or may not reflect the payload's actual orientation in the real world.

The object segmentation system 242 can be turned on when the AMR 100 is in close proximity to the payload 106 and/or infrastructure and then turned off upon completion of engaging the payload for transportation by the AMR. Turning on the object segmentation system 242 can be in response to detection of the payload and/or infrastructure supporting the payload by the sensor 150 or by localizing the AMR relative to the payload location, or some combination thereof. Turning off the object segmentation system 242, to no longer exclude the 3D regions 160, 170 from obstruction detection can be in response to the AMR recognizing that the payload is loaded onto the AMR, through data from one or more of the sensors 150, load sensors in the forks 110a,b, or manual input to the AMR, as examples.

When turned on, the object segmentation system 242 generates a first 3D region, payload box 160, around the payload 106 based on the determined pose of the payload and the expected pose of the payload. The object segmentation system further generates a second region, chassis box 170, between forks 110a,b of the AMR 100 and outriggers 108 of the AMR based on the expected pose of the payload and an expected pose of the AMR. The object segmentation system 242 is configured to filter out points from the sensor data, e.g., point cloud data acquired by the 3D sensors, based on the first and second regions 160, 170. That is, point cloud data representing objects in the first and second 3D regions will not be used for obstruction detection or otherwise interpreted as obstructions for navigation purposes.

In various embodiments, the sensors 150 comprise at least one of a LiDAR scanner and/or one or more 3D cameras, e.g., stereo cameras.

An object segmentation method allows the AMR 100 to interact with a specified payload, while avoiding all other objects. As discussed above, the method includes generating a 3D exclusion region 160 around the payload 106 with which the AMR will be interacting and generating a 3D exclusion region 170 between the forks 110a,b and the outriggers 108 to allow the forks 110a,b to move in above infrastructure 180 supporting the payload 106 while the outriggers 108 move in below the infrastructure 180. The infrastructure 180 can comprise a table top or shelf, as shown in FIG. 2.

A pallet detection system 200, for example, can be used to find and localize the payload 106 using stored semantic data about the payload and pose data for the payload. Once detected, the object segmentation system 242 can then generate the 3D box region 160 around the payload. As discussed, points in the 3D region 160 will be segmented out from the overall point cloud data from the sensors 150 for the purposes of obstruction detection. Data about the expected pose of the payload interaction hardware and expected pose of the AMR 100 itself are used to generate a second 3D box region 170 between the payload interaction hardware (e.g., forks 110a,b) and other portions of the AMR hardware (outriggers 108) that are below it that will be used to ignore any points in the point cloud that can be straddled by the AMR hardware. This allows the AMR 100 to straddle the infrastructure 180, if the lower portion of the chassis 190 is able to fit underneath it, while the forks 110a,b above the infrastructure 108 interact with a payload 106 on top of it, which allows a wider range of poses the payload 106 can be in such that the AMR 100 is able to interact with it.

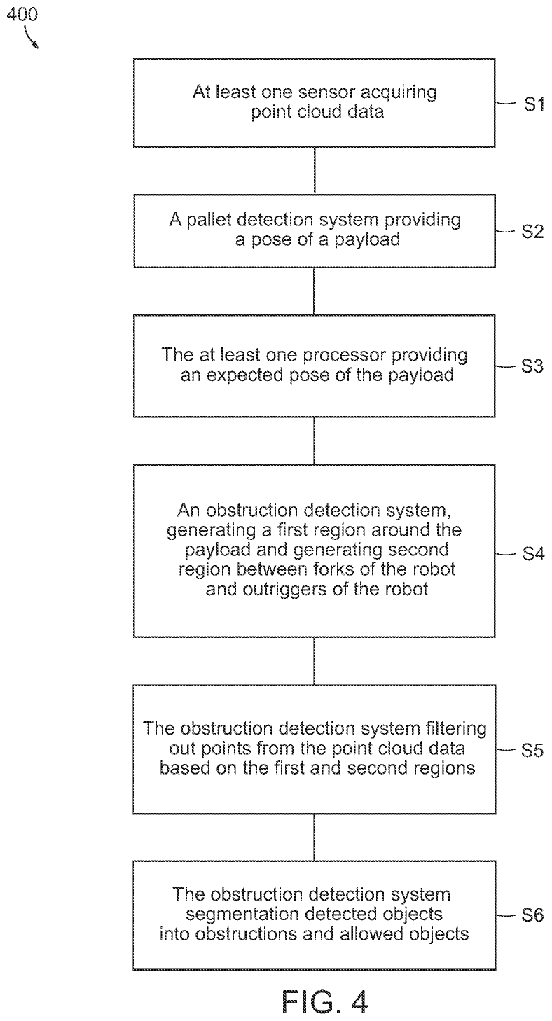

FIG. 4 is a block diagram of a method 400 of the AMR forklift of FIGS. 1, 2, and 3 using object segmentation to segment detected objects into obstructions and allowed objects, such as payloads.

The method 400 of the AMR 100 includes the at least one sensor 150 acquiring point cloud data (S1); a pallet detection system 200 providing a pose of a payload (S2); the at least one processor 235 providing an expected pose of the payload (S3); the object segmentation system 242 generating a first region 160 around the payload based on the pose of the payload and the expected pose of the payload and generating a second region 170 between forks 110a,b and outriggers 108 of the AMR 100 based on the expected pose of the payload and an expected pose of the AMR (S4); the object segmentation system 242 filtering out points from the point cloud data within the first and second regions 160, 170 (S5); and the object segmentation system 242 segmenting detected objects into obstructions and allowed objects based on the point cloud data, the pose of the payload, and semantic data about the payload (S6).

Various embodiments of the system use the following as inputs:
1. The pose of the payload that the AMR 100 will be interacting with. This pose can be provided by the pallet detection system 200 processing sensor data from one or more of sensors 150, or could be provided by an external system, such as data provided by an external server or system in communication with the AMR.
2. The goal pose of the AMR necessary to interact with the payload appropriately. This goal pose is provided by the AMR's 100 planning subsystem. This goal pose is understood to be a position at which the AMR 100 will stop and be stationary while interacting with the payload. This goal pose is the orientation of the AMR to the pallet that enables the AMR to slide the forks 110a,b into fork pockets of the pallet.
3. Point clouds produced by one or more of the sensors 150 that observe the surrounding environment of the AMR 100, which can be used for object detection. Any type of sensor that can provide point clouds may be used, including, but not limited to, LiDAR and stereo cameras.

Using the first two inputs, two 3D boxes are generated:
1. The “Payload Box” 160: A 3D box around the payload pose that encloses the payload. This box 160 is shaped to closely fit the expected payload.
2. The “Chassis Box” 170: A 3D box relative to the goal pose of the AMR 100. This box 170 is shaped to fit between the protruding portions 108 of the AMR 100, such as outriggers on the floor, and raised forks 110,a,b in the air, with the box covering the area that will NOT be occupied by any portion of the AMR 100 once it reaches the goal pose.

FIG. 2 is a diagram illustrating the 3D boxes or regions 160, 170 generated by the object segmentation system 242, in accordance with aspects of the inventive concepts. These 3D boxes or regions 160, 170 can then be used to filter out points from the point clouds provided by the third input, which has the effect of eliminating any points in the point cloud from being considered as obstructions. The payload box 160 thus allows the AMR 100 to make contact with and engage the payload 106 in order to interact with it, e.g., insert forks 110a,b into fork pockets of a pallet 104 on which goods are located, while the chassis box 170 allows the protruding portions 108 of the AMR 100 to straddle any infrastructure 180 the payload is resting on top of.

By segmenting out these regions and excluding only these regions from the point clouds, the AMR 100 is still able to detect any other objects that the AMR 100 might encounter as obstructions and, thus, be able to prevent collisions with other objects while still being able to properly interact with the payload 106, as desired.

The object segmentation system and method can be selectively turned on when the payload is detected by the sensors or the AMR is otherwise proximate the payload and can be turned off again when the payload has been “picked,” e.g., the pallet 104 is carried by the forks 110a,b.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

1. An autonomous mobile robot (AMR), comprising:
at least one processor in communication with at least one computer memory device;
at least one sensor configured to acquire point cloud data;
a pallet detection system configured to provide a pose of a payload; and
an object segmentation system comprising computer program code executable by the at least one processor to segment detected objects into obstructions and allowed objects based on the point cloud data, the pose of the payload, and semantic data about the payload.

2. The robot of claim 1, wherein the at least one processor provides an expected pose of the payload.

3. The robot of claim 2, wherein the object segmentation system generates at least one first region around the payload based on the pose of the payload and the expected pose of the payload.

4. The robot of claim 3, wherein the at least one first region is an at least one three-dimensional box.

5. The robot of claim 3, wherein the object segmentation system generates at least one second region between forks of the robot and outriggers of the robot based on the expected pose of the payload and an expected pose of the robot.

6. The robot of claim 5, wherein the at least one second region is an at least one three-dimensional box.

7. The robot of claim 4, wherein the object segmentation system is configured to filter out points from the point cloud data based on the at least one first region and the at least one second region.

8. The robot of claim 7, wherein the processor is configured to not use the filtered out points for obstruction detection.

9. The robot of claim 1, wherein the at least one sensor comprises at least one of a LiDAR scanner and a 3D camera.

10. The robot of claim 1, wherein the AMR includes a pair of forks and the payload is a palletized payload.

11. An object segmentation method for use by autonomous mobile robot (AMR), the method comprising:
at least one sensor acquiring point cloud data;
a pallet detection system providing a pose of a payload; and
an object segmentation system segmenting detected objects into obstructions and allowed objects based on the point cloud data, the pose of the payload, and semantic data about the payload.

12. The method of claim 11, including the at least one processor providing an expected pose of the payload.

13. The method of claim 11, including the object segmentation system generating at least one first region around the payload based on the pose of the payload and the expected pose of the payload.

14. The method of claim 13, wherein the at least one first region is an at least one three-dimensional box.

15. The method of claim 13, including the object segmentation system generating at least one second region between forks of the robot and outriggers of the robot based on the expected pose of the payload and an expected pose of the robot.

16. The method of claim 15, wherein the at least one second region is an at least one three-dimensional box.

17. The method of claim 11, including the object segmentation system filtering out points from the point cloud data based on the at least one first region and the at least one second region.

18. The method of claim 17, including the processor excluding the filtered out points for obstruction detection.

19. The method of claim 11, wherein the at least one sensor comprises at least one of a LiDAR scanner and a 3D camera.

20. The method of claim 11, wherein the AMR includes a pair of forks and the payload is a palletized payload.
